(19) United States
(12) Patent Application Publication
(10) Pub. No.: US 2011/0106660 A1
(43) Pub. Date: May 5, 2011

(54) METHOD FOR PROVIDING LEARNING AS A SERVICE (LAAS) IN A LEARNING NETWORK

(76) Inventors: Gopala Ajjarapu, Cupertino, CA (US); Farhat Ali, Saratoga, CA (US); Pratap Chillakanti, Fremont, CA (US); Udayakumar S. Puduvankunnil, Fremont, CA (US)

(21) Appl. No.: 12/939,413

(22) Filed: Nov. 4, 2010

Related U.S. Application Data
(60) Provisional application No. 61/258,410, filed on Nov. 5, 2009.

(51) Int. Cl. G06Q 30/00; G06F 15/18; G06F 17/30

(52) U.S. Cl. 705/26.41; 706/12; 707/706; 707/E17.108

(57) ABSTRACT

The present invention contemplates a variety of improved methods and systems for providing learning of the service (LaaS) in a learning network. At least certain embodiments include systems, methods, and apparatuses for connecting users with providers of pedagogic or professional content using an online marketplace for self-directed learning. The online marketplace includes a database of searchable content, availability of content experts and subject matter experts for guidance, and community support from peers and colleagues. A web-based graphical user interface is provided to users via the learning network to enable user interaction with the content and allow users to control the content and the pace of learning. Requests for particular content can be received from users and those requests can be fulfilled without regard to the location of the content or time of access, enabling self-directed learning. The content can be decomposed into monetized components, which can be accessed by users on a per-use or per-session basis.

### PRIORITY

The present patent application claims priority to and incorporates by reference the corresponding provisional patent application No. 61/258,410, entitled, “Learning-Based Social Network” filed on Nov. 5, 2009.

### FIELD OF THE INVENTION

At least certain embodiments of the invention relate generally to self-directed learning in a network, and particularly to providing learning as a service (LaaS) in a networked learning marketplace.

### BACKGROUND OF THE INVENTION

Conventional websites and applications provide useful services for people having various needs. For example, for buying and selling there are websites such as eBay and Amazon. For networking there are websites such as LinkedIn, and for social networking there are various websites such as Facebook, Twitter, and YouTube.

The need for continuing education is growing. Individuals need to be lifelong learners, constantly upgrading their skills to remain employable. Corporations face the daunting challenge of keeping their global professional employees and partners fully trained while minimizing downtime and managing costs. On the supply side, content providers are under pressure to increase their top line and are always looking for new ways to increase reach as well as provide additional services. In spite of technological advances, the cost of education continues to rise without an increase in effectiveness.

Various methods of providing education exist including e-learning companies and content providers, learning management systems, and free web content. Each of these has its own disadvantages. For example, e-learning companies and content providers suffer from the fact that they are fragmented and provide their own content instead of providing an open system where any number of content providers can contribute to the educational process. On the other end of the spectrum, are the free web content providers, but these often have very limited mechanisms for allowing users to search for content and lack quality control over the content. Learning management systems are often internally oriented proprietary systems, and suffer from some of the same disadvantages as other e-learning systems.

There are numerous online educational institutions, such as e-learning companies and providers of learning management systems; however, none of these offer a go-to-place for self-directed learning in an open infrastructure that accepts content in any format or multiple formats; and that decomposes the content into monetizable components to be provided on a per-use or per-session basis.

### SUMMARY OF THE DESCRIPTION

The present invention contemplates a variety of improved methods and systems for providing learning as a service (LaaS) in a learning network. At least certain embodiments include methods and apparatuses for connecting users with providers of pedagogic or professional content using an online marketplace for self-directed learning. The online marketplace includes a database of searchable content. Various embodiments disclosed herein provide a web-based graphical user interface window to users via the learning network to enable user interaction with the content and to allow users to control the content and pace of learning. Embodiments of the invention include a learning platform operable to receive requests for content and to fulfill those requests without regard to the location of the content or time of access, enabling self-directed learning. And in at least certain embodiments, the content can be decomposed into monetized components, which can be accessed by users on a per-use or per-session basis. Self-directed learning is also facilitated by providing users with online availability of experts, peers, colleagues, and community members.

The learning platform is configured to provide learning as a service. In one embodiment, the learning platform includes a learning engine coupled with a database of searchable pedagogic or professional content to generate an online marketplace for self-directed learning. The learning engine includes a communication engine that connects users of the learning network with providers of content, experts, and other community members; and is configured to provide the user with a web-based graphical user interface window to enable user interaction with the content and the community. The learning engine enables user control over the content and pace of learning. Any hardware that can provide an Internet browser can be used by users to access the learning platform.

### BRIEF DESCRIPTION OF THE DRAWINGS

For a better understanding of at least certain embodiments, reference will be made to the following Detailed Description, which is to be read in conjunction with the accompanying drawings, wherein:

FIG. 1a depicts an illustrative block diagram of a learning network according to one embodiment of the invention.

FIG. 1b depicts an illustrative flow chart showing how various users interact with the learning network according to one embodiment of the invention.

FIG. 2a depicts an illustrative block diagram of the learning platform according to one embodiment of the invention.

FIG. 2b depicts an illustrative block diagram of the system architecture of the learning platform according to one embodiment of the invention.

FIG. 3 depicts an illustrative process of providing learning as a service in a learning network according to one embodiment of the invention.

FIG. 4 depicts an illustrative screenshot of a homepage within a graphical user interface according to one embodiment of the invention.

FIG. 5 depicts an illustrative screenshot of a self-directed online marketplace within a graphical user interface according to one embodiment of the invention.

FIG. 6 depicts an illustrative screenshot of a detailed course listing within a graphical user interface according to one embodiment of the invention.

FIG. 7 depicts an illustrative screenshot of a learner's window within a graphical user interface according to one embodiment of the invention.

FIG. 8 depicts an illustrative screenshot of an expert chat session within a graphical user interface according to one embodiment of the invention.

FIG. 9 depicts an illustrative screenshot showing the use of time-stamps, searchable notes within a graphical user interface according to one embodiment of the invention.

FIG. 10 depicts an illustrative screenshot of a community window within a graphical user interface according to one embodiment of the invention.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

Systems, methods, and apparatuses to provide learning as a service in a learning network are disclosed. At least certain embodiments provide a transformative solution combining pedagogy and technology to address learning over a network where the learner, not the teacher, is at the hub and is able to procure learning resources on-demand. As such, these embodiments provide integrated systems that reinforce active learning. As used herein, the term active learning is defined to include a self-directed, expert-guided, community-enabled learning process. Active learning is self-directed learning where the learner can call on learning resources such as content, experts, and community resources on-demand. Active learning can be achieved by the integration of rich multimedia content, expert coaching, and community collaboration. As such, embodiments enable a learning environment where education is affordable, accessible, and effective by placing the learner at the hub of the learning—the learner has the ability to control both the content and pace of learning and can interact with expert as well as peers to facilitate the learning process.

The advent of the cloud computing model, the prevalence of social media technologies, and the explosion of network bandwidth have made it possible to create a collaborative network for learning. Use of collaboration tools is provided to facilitate setting individual learning goals and to allow learners to search for and obtain pedagogic or professional content on a per-use or per-session basis. Learners are able to receive guidance and feedback from experts in the applicable content. Embodiments also include a real-time collaborative learning environment with integrated networking and socializing opportunities.

Advantages of the various embodiments include: (1) content providers are able to increase their revenue through a global distribution channel, as well as provide additional services such as online use of subject matter experts and establish client relationships for future business; (2) content or subject matter experts are able to monetize their skills; (3) individuals gain flexibility and learning while ensuring learning outcomes are met at a significantly lower cost than any other method, and also able to build their networks. Learners are able to learn a skill more efficiently without affecting learning outcomes by taking self-paced courses and interacting with a coach or expert for advice and feedback. It should be noted, however, that the description herein is not limited to self-paced courses, as the option for live educational content is also contemplated within the scope of various embodiments described herein. Content providers are able to significantly increase sales by increasing reach while achieving time and location flexibility. In effect, embodiments disclosed herein allow operators of a learning platform within the learning network to act as an agent between learners and the content providers, and to provide learning as a service (LaaS) using an on-demand model.

Content providers can set prices and will have an agency agreement with the learning platform provider. Content providers may also appoint content experts, and the revenue from these experts may flow to the content provider who would then have a separate financial relationship with the expert. Moreover, the online marketplace for self-directed learning can be separated into multiple domains including public domains and private domains. In general, the private domains will have the same functionality as public domains, but may be limited to a designated group of people, such as within a particular enterprise. Enterprises and content providers are able to create their own domains within the public system. In one embodiment, this can be accomplished through cloud-based computing, although the invention is not so limited as other computing models can be used.

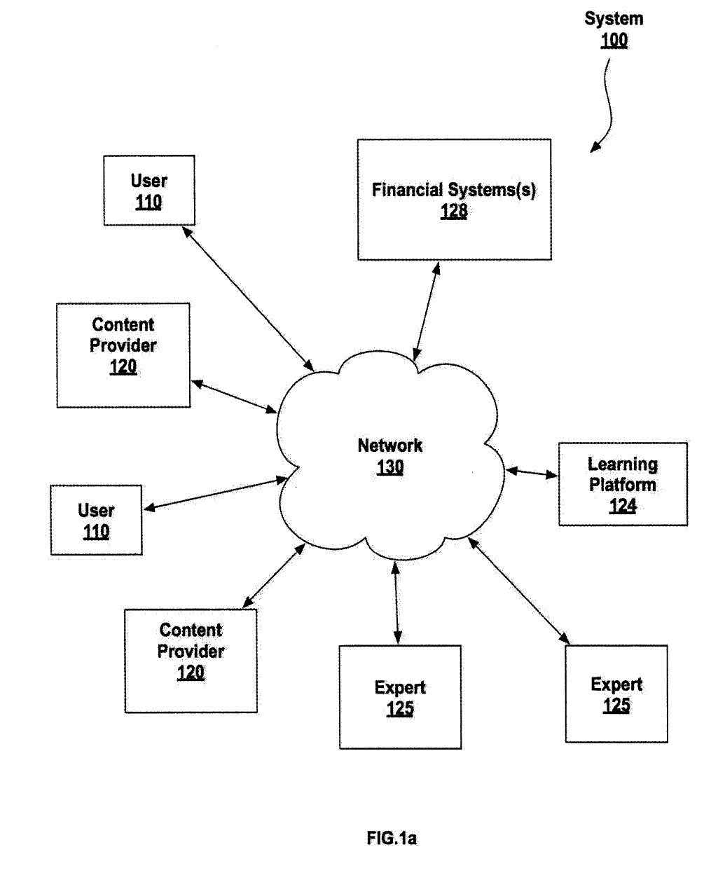

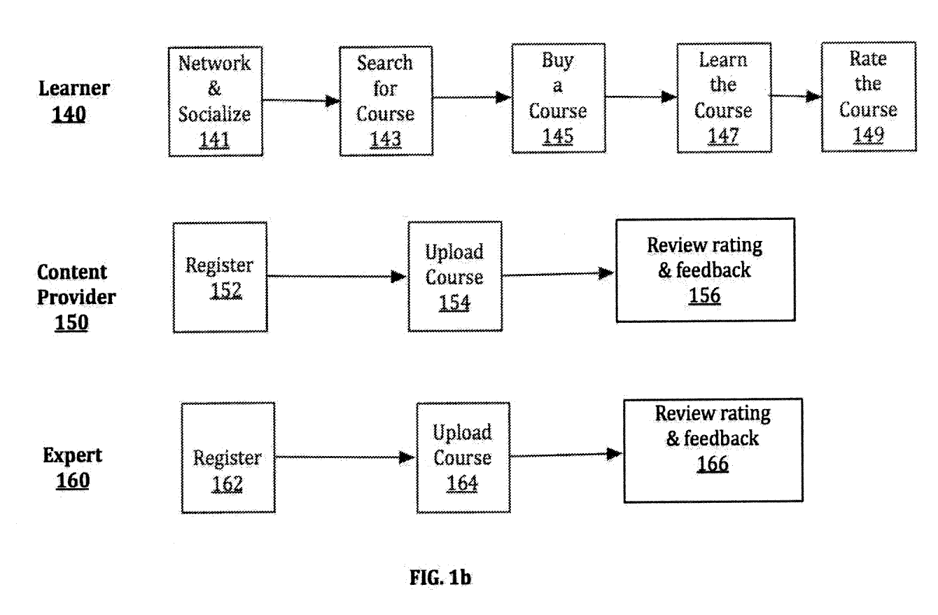

FIG. 1a depicts an illustrative block diagram of a learning network according to one embodiment. In the illustrated embodiment, system 100 includes a learning platform 124 connected to multiple user devices 110, content providers 120, and experts 125 via a network 130. The user devices 110 typically include display or other output functionalities to present data exchanged between the device and a user. The user devices may include any hardware configuration that has Internet browser capability. For example, the user devices may be desktop or laptop computers, mobile phones, PDAs or other handheld devices, etc. In addition, network 130 maybe any type of communications network. For example, network 130 may be a telephonic network, an open network such as the Internet, or a private network such as an intranet or extranet. Network 130 may also be a single network or any collection of distinct networks operating wholly or partially in conjunction to provide connectivity to the user devices 110, and may appear as one or more networks. The user devices 110, content providers 120, and experts 125 may be coupled with the network 130 via any connection that supports Internet browsing such as a dial-up connection, digital subscriber loop (DSL, ADSL), cable modem connection, or any other type of connection allowing these devices to communicate with remote servers (e.g., web server, host server, mail server, or instant messaging server) to provide access to the network 130.

System 100 further includes one or more financial systems 128 coupled with the learning platform 124 via network 130. The financial systems 128 can be implemented as hardware or software, or combination thereof, and are configured to communicate with the learning platform 124 to provide billing, collections, and corporate reporting functionality for the learning network. In at least certain embodiments, financial systems 128 are configured to facilitate transactions over the learning network so that users can purchase pedagogic or professional content and related artifacts such as books, digests, or other multimedia. Financial systems 128 may also be configured to facilitate transactions between users and experts, on a per-session basis.

FIG. 1b depicts an illustrative flow chart showing how various users may interact with the learning network. The illustrated embodiment shows some of the functionality of the learning network and interactions available for users, content providers, and experts. For example, learner 140 can network and socialize 141, search for a course 143, purchase a course 145, learn a particular course 147, and rate the course 149 using the learning network. Content providers 150 can, for example, register their course 152 on the learning network, upload a course 154 to the learning network, and review rating and feedback 156 provided by users of the learning network. And experts 160 may also register as an expert with the learning network 162, upload courses 164 and review rating and feedback 166 provided by users of their services. In this way, the learning network described herein provides an online marketplace for self-directed learning that integrates learning content, and expert and community guidance, networking and feedback all within a single learner's window. From the learner's window, users can choose and learn from among a variety of course categories and topics, take notes, and interface with experts and other community members using chat or email to receive guidance and feedback among other things. Users can also provide feedback on content, experts, and content providers that can be used by other users to determine whether to take a particular course from a particular content provider, or engage with a particular expert. In at least some embodiments, users can also vote on feedback provided by other users.

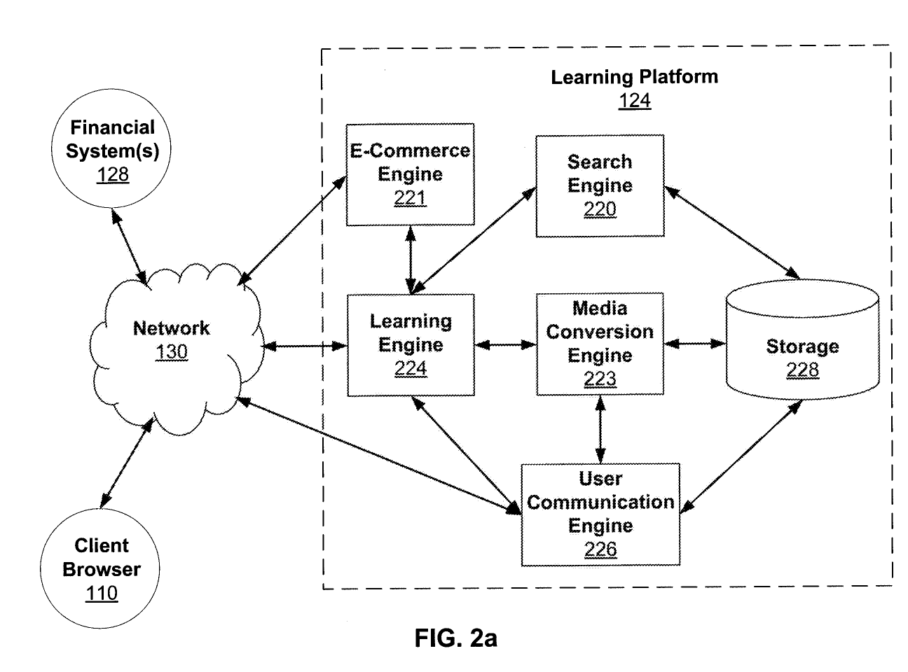

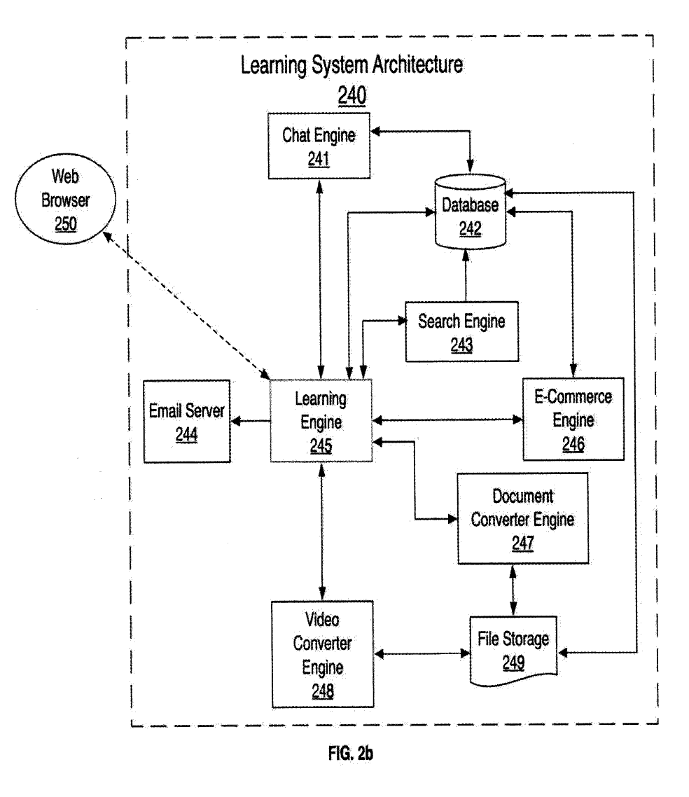

FIG. 2a depicts an illustrative block diagram of the learning platform 124. In the illustrated embodiment, learning platform 124 includes: (1) user communication engine 226 coupled with network 130; (2) a learning engine 224; (3) a search engine 220; (4) storage 228; (5) a media conversion engine 223; and (6) e-commerce engine 221. User communication engine 226 is configured to connect users of the learning network with providers of pedagogic or professional content using an online marketplace for self-directed learning. User communication engine 226 provides communications between a user's client browser 110 and the learning platform 124. Learning engine 224 receives communications from the user client browsers 110 via network 130 and performs the necessary processing of those communications. Learning engine 224 may be implemented as hardware, software, firmware, or any combination thereof including hybrid circuits. The learning engine 224 provides all the functionality without the users having to store any client software on their local devices. Users can upload and play various content within their local browser. In fact, certain embodiments only require users to have an Internet browser-compatible device that enables them to interface with the learning engine 224 within a single browser window. Learning engine 224 is configured to receive pedagogic or professional content from various content providers and to store that content in storage 228. Learning engine 224 has the ability to perform the following illustrative functionality: (1) upload courses, including multiple modules and sub-modules; (2) provide course summaries, authors, and other course information; (3) assign content experts to various courses; and (4) establish pricing for content and content experts, among other things.

In the illustrated embodiment, learning engine 224 is coupled with search engine 220 to provide responses to users' queries when they desire to search for content within the online marketplace. Searches may be characterized in four major categories: (1) global searching of everything on the learning platform; (2) knowledge base searching of all supporting learning material; (3) course searching from the storage 228; and (4) community searching for specific members by role, name, expertise, etc. As used herein, the term knowledge base refers to a searchable storehouse of information (e.g., white papers, case studies, course catalogs, community boards, FAQs, blogs, etc.) in a particular domain accessible to members of that domain. In the illustrated embodiment, learning engine 224 is further coupled with storage 228 via media conversion engine 223. Storage 228 receives and stores pedagogic or professional content from content providers in a searchable format. In one embodiment, tags are provided to facilitate searching. Additionally, storage 228 includes a cataloging system that consists of categories, subjects, and content (courses). This cataloging system is dynamic, and as the content library increases, courses can be tagged with their respective subject, and additional subjects can be added at any time. Online catalogs are also provided and are searchable by category, subject, author, or content provider. A course can be viewed as a packaged unit of learning. Each course may have a set of one or more modules and each of these modules can have sub-modules. Each course is not limited to a particular type of module format. For example a course may have any number of different formats including video, audio, or document formats, or any combination thereof.

Learning engine 224 is capable of essentially decomposing the learning process into its components and to use technology to reassemble those components into monetizable components that can be separately priced. This facilitates self-directed learning by enabling each learner to purchase various components of the learning process separately, to store them in the learning platform 124, and to interact with the content in a self-paced, on-demand manner. That is, the components of the learning process can be broken down so as to allow the learner, not the instructor or content provider, to direct the time, place, and manner of learning. The users essentially have remote control over the learning process. Media conversion engine 223 operates in conjunction with learning engine 224 to facilitate this aspect of the learning process.

Media conversion engine 223 can be configured to provide requested content to users in their client browsers 110 regardless of the format of the content. Media conversion engine 223 can convert various formats of content stored in storage 228 into content having a format compatible with that user's client browser 110. For example, if a user client browser 110 operates using an Apple Macintosh or other Macintosh-compatible computer or device, media conversion engine 223 can convert the content stored in storage 228 into a format compatible with that particular computer or device. In addition, media conversion engine 223 can convert between video, audio, and text within documents upon user request, or if a particular media format is not compatible with the user's client browser. For client browsers 110 that do not support a particular media content, media conversion engine 223 can nevertheless convert that media content into a format compatible with any client browser 110. For example, at least certain embodiments are compatible with the Google Web Toolkit (GWT), which is an open source set of tools that allows web developers to create and maintain complex JavaScript front-and applications in Java.

Storage 228 includes a learner's vault database configured as a personal storage system for user data such as notes, chat sessions, and other information specific to a particular user. The notes and chat sessions can be time-stamped, searchable, and are linked to particular content allowing users to reference that content at the specific place in the course where the particular note was taken or chat session was initiated. Chat is a collaboration functionality which is available to learners and can be text, audio, or video format. Storage 228 also includes a profile database configured to store user profile data. Users can create a profile that includes name, address, etc. Once a user signs up for the learning service, that user will create a profile, which can then be stored in the profile database 234.

The definition of user encompasses all of learners, content providers, and experts as depicted, for example, in FIG. 1b. That is, users can be strictly learners, administrators of content providers, or identified as experts. An expert is a specific role which a user must be qualified to perform. There are two types of experts: content experts and subject matter experts. Content experts are associated with a particular pedagogic or professional content provided by a particular content provider. Such content experts can be utilized as a resource for collaborative learning. Users taking a particular course can search for content experts associated with a particular course, and can ask questions using chatter e-mail and receive guidance and feedback from those experts. Experts are generally pre-screened by the content provider, and therefore, verification of their credentials may not be necessary in all cases. Subject matter experts, on the other hand, are experts associated with a particular subject matter, and not necessarily with a particular course or content provider. At least certain embodiments, subject matter experts must be verified by submitting their credentials and requesting to be associated with a particular pedagogic or professional content. Once a user's credentials have been verified to meet a standard for the particular subject matter, that user can be listed as a subject matter expert, and will henceforth appear in search results for that subject matter. Subject matter experts can be utilized as a resource for learning in the same way as content experts, and they are searchable through the system based on their credentials and corresponding subject matter. In addition, learners can provide feedback on each subject matter expert, based on their experience with that expert. This feedback is collected over time and is used to rate the quality and effectiveness of experts. Unlike content experts, however, subject matter experts are generally engaged directly by the user and do not involve the content providers. As such, engaging a subject matter expert generally requires a separate agreement between the expert and learner. This allows the expert to monetize their expertise in the subject matter in much the same way as the content.

Finally, learning platform 124 further includes an e-commerce engine 221 coupled with one or more financial systems 128 via network 130. The e-commerce engine 221 can be implemented as hardware or software, or combination thereof, including a hybrid circuit; and is configured to communicate with financial systems 128 to provide billing, collections, and corporate reporting functionality for the learning platform 124. In at least certain embodiments, e-commerce engine 221 is configured to work with the financial systems 128 to facilitate transactions over the learning network.

FIG. 2b depicts an illustrative block diagram of the system architecture of the learning platform according to one embodiment. In the illustrated embodiment, learning system architecture 240 includes a learning engine 245, database 242, e-commerce engine 246, search engine 243, e-mail server 244, chat engine 241, document converter engine 247, video converter engine 248, and file storage 249.

FIG. 2b depicts an illustrative block diagram of the learning platform 124. In the illustrated embodiment, learning platform 124 includes: (1) user communication engine 226 coupled with network 130; (2) a learning engine 224; (3) a search engine 220; (4) storage 228; (5) a media conversion engine 223; and (6) e-commerce engine 221. In this embodiment, learning engine 245 is configured to connect users of the learning network with providers of pedagogic or professional content using an online marketplace for self-directed learning. Learning engine 245 provides communications between a user's web browser 250 and the other components of the learning system architecture 240. Learning engine 245 receives communications from the user web browsers 250 via a network or other connection; and performs the necessary processing of those communications. Learning engine 245 may be implemented as hardware, software, firmware, or any combination thereof including hybrid circuits. Learning engine 245 is coupled with database 242. Learning engine 245 is configured to receive pedagogic or professional content from various content providers (not shown) and to store that content in database 242. Learning engine 245 is also coupled with e-mail server 244 and chat engine 241 to facilitate chat and email exchanges among users, community members, content providers, and experts. Chat engine 241 is also coupled with database 242. Chat engine 241 provides chat sessions and updates user data accordingly, storing it back to user database 242. E-mail server 244 is coupled with learning engine 245. E-mail server 244 is configured to provide e-mail functionality to facilitate email exchanges among users, community members, content providers and experts.

In the illustrated embodiment, learning engine 224 is coupled with search engine 243 to provide responses to users' queries when they desire to search for content within the online marketplace. Database 242 receives and stores pedagogic or professional content from content providers in searchable format. Learning system architecture 240 includes file storage 249 coupled with database 242. File storage 249 can be configured to provide files of various formats to users via the learning engine 245. As such, learning engine 245 is further coupled with video converter engine 248 and document converter engine 247. As discussed above, users have remote control over their learning process. Video converter engine 248 and document converter engine 247 operate in conjunction with learning engine 245 to facilitate the learning process, and to convert between various media formats upon request of the user, to facilitate network bandwidth, or to address compatibility issues with users web browsers 250, etc. Video converter engine 248 converts between video file formats and any other media format, including documents and text. Similarly, document converter engine 247 converts between document file formats and any other media format including video and audio. In addition, document converter engine 247 converts among different formats of documents to maintain compatibility with users web browsers 250, etc. In any event, the combination of document converter engine 247 and video converter engine 248 is operable to provide requested content to users in their client browsers 250 regardless of the format of the content and regardless of the format utilized by a particular user's web browser 250.

Database 242 includes a personal storage system for user data such as notes, chat sessions, and other information specific to a particular user. Database 242 also includes a profile database configured to store user profile data.

Finally, learning platform 124 further includes an e-commerce engine 246 coupled with one or more financial systems 128 (not shown) via any network. The e-commerce engine 246 can be implemented as hardware or software, or combination thereof, including a hybrid circuit; and is configured to communicate with financial systems to provide billing, collections, and corporate reporting functionality for the learning system architecture 240. In at least certain embodiments, e-commerce engine 246 is configured to work to facilitate transactions over the learning network.

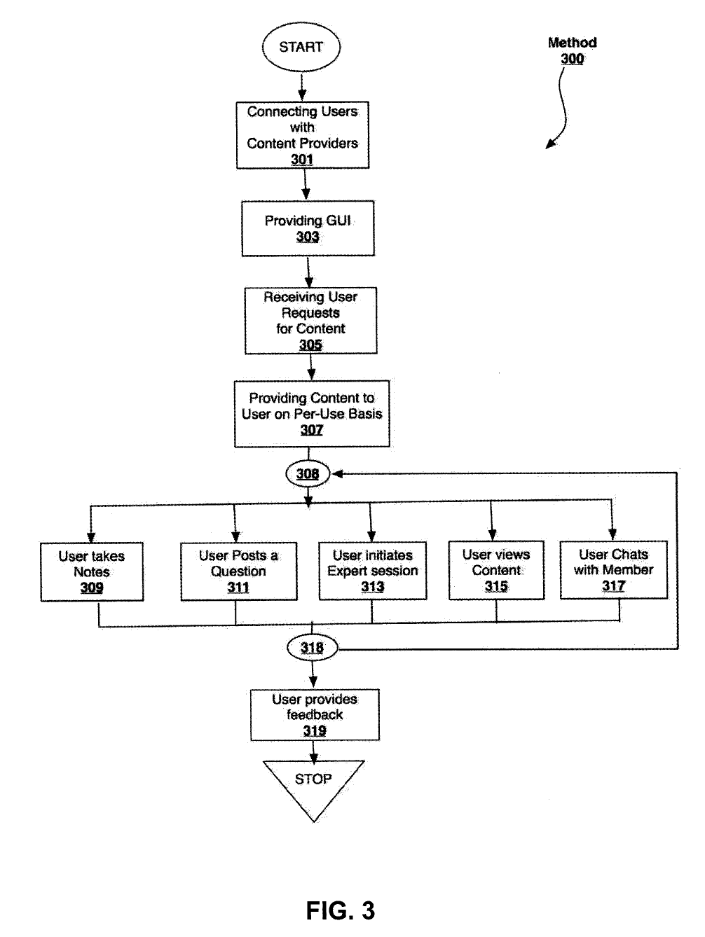

FIG. 3 depicts an illustrative process of providing learning as a service in a learning network. Method 300 begins at operation 301 where users are connected with providers of pedagogic or professional content using the learning network to facilitate the creation of an online marketplace for self-directed learning. The learning platform, at operation 303, then provides the user with a web-based graphical user interface (GUI) in a single learning window that allows the user to interact with the content without regard to time of access or location of that content, and to allow users to control both the content and pace of learning. From the single learning window, users can search for and request content from the learning platform (operation 305), and the learning platform responds by providing the requested content to the user on a per-use or per-session basis (operation 307). As discussed above, users interact with learning system through a single user window. At operation 308, users can take notes in the learner's window (operation 309), post a question to the community or an expert (operation 311), initiated expert session (operation 313), view content (operation 315), or chat with other members of the community or experts (operation 317). For example, users may view content, take notes, post questions to other community members, and initiate a request session with an expert, as examples, to enhance their learning process through self-direction. Users have control over the learning process, including what the users desire to learn, who the users desire to interact with to facilitate the learning, and the pace at which the user desires to learn. In addition, users may additionally provide feedback on content as well as on the expert (operation 319). This completes method 300 according the illustrated embodiment.

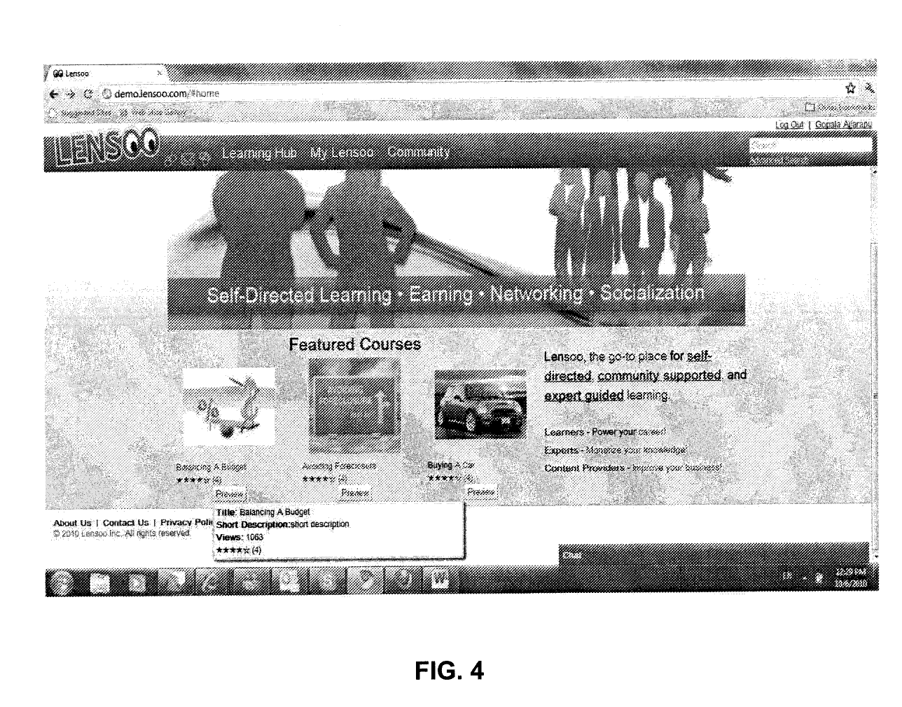

FIG. 4 depicts a screenshot of a homepage within the graphical user interface. In the illustrated embodiment, the homepage allows a user to preview courses, and to access various other aspects of the learning platform including accessing the learner's window and various community groups. When a user has registered to become a member of the learning network, the user is taken to the homepage which can be customized by the user. The homepage can have a default of home but can also include the following functionality: learning hub (browse for courses); manage profile (edit profile to request changes to rules); community (network and socialize); content provider (upload, modify courses, content feedback, content provider reports, etc.); content or subject matter experts (ask an expert response gadget, expert feedback, expert measurement reports); and system administrator tools. In addition, the homepage includes notifications to the user from community members, responses from experts; chat responses; and question responses.

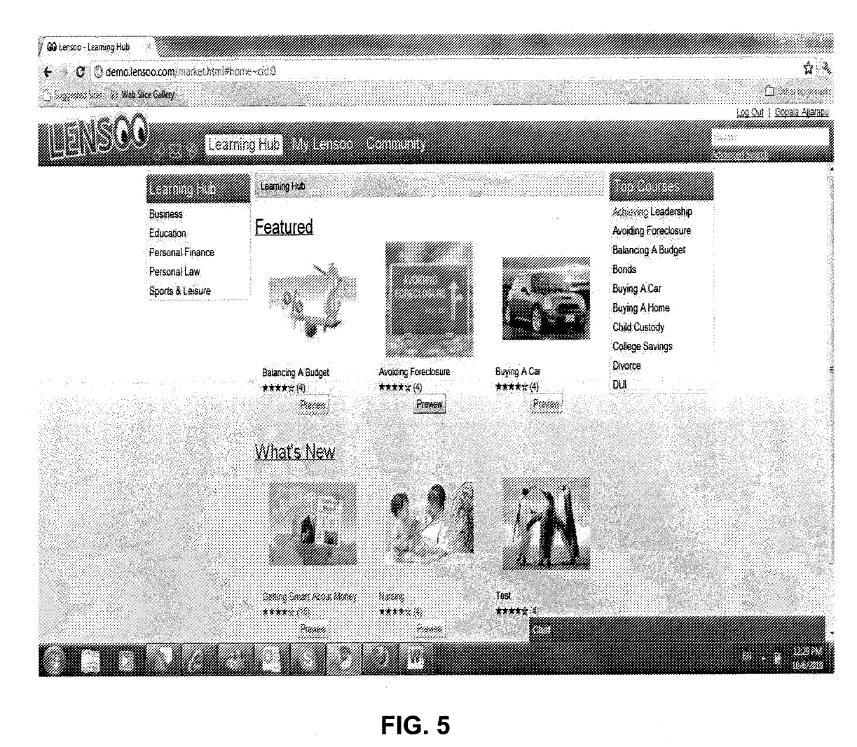

FIG. 5 depicts a screenshot of a self-directed online marketplace. In the illustrated embodiment, the online marketplace allows users to preview courses (featured courses, new courses, top courses, or courses by subject area), and navigate the content from various content providers.

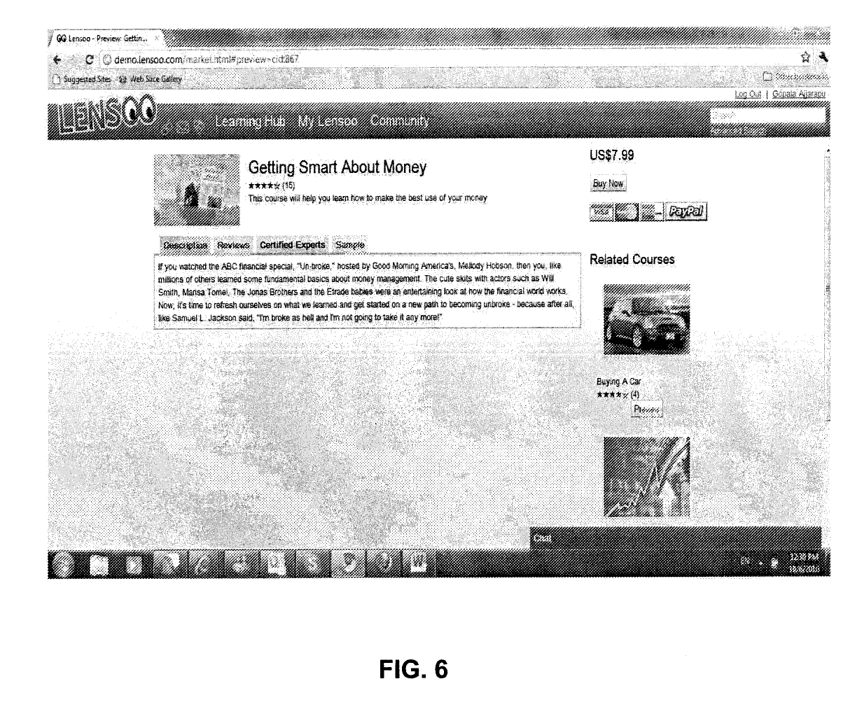

FIG. 6 depicts screenshot of a detailed course listing within the graphical user interface. In the illustrated embodiment, the detailed course listing includes a brief description of the course, various learner reviews of the course, and the price for that particular course. In addition, the detailed course listing allows users to search and contact certified content experts for the course.

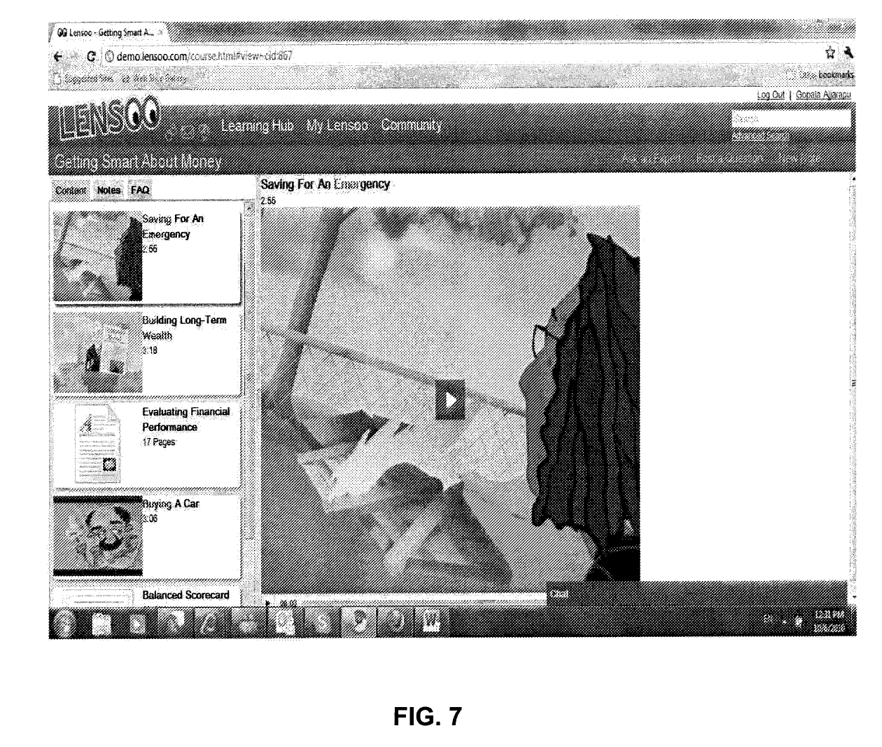

FIG. 7 depicts a screenshot of a learner's window within the graphical user interface. In the illustrated embodiment, the web-based GUI is a single-window GUI referred to as the learner's window. The learner's window is the place from where a learner engages in active learning including taking a course, chatting with community members, interfacing with one or more experts, posting questions, taking notes, etc. The learner can view any module, take notes, chat with a contact, and request an expert session, or post a question to the community. From the learner's window, the learner is able to navigate the content of a course and choose the appropriate starting point. After the learner has viewed a course, the next time the course is opened, the learner can go directly to the point where he or she left off. The learner is further able to take tests based on the subject matter, where there is functionality for the results to be posted on a user dashboard or other mechanism or device that tracks user progress. Additionally, the course and its associated notes can be saved by the user as desired in the learner's vault database. And learners can download content in any format, view that content and modify it as it fits the user's convenience. But in at least certain embodiments, this ability to download is under the control of the content provider.

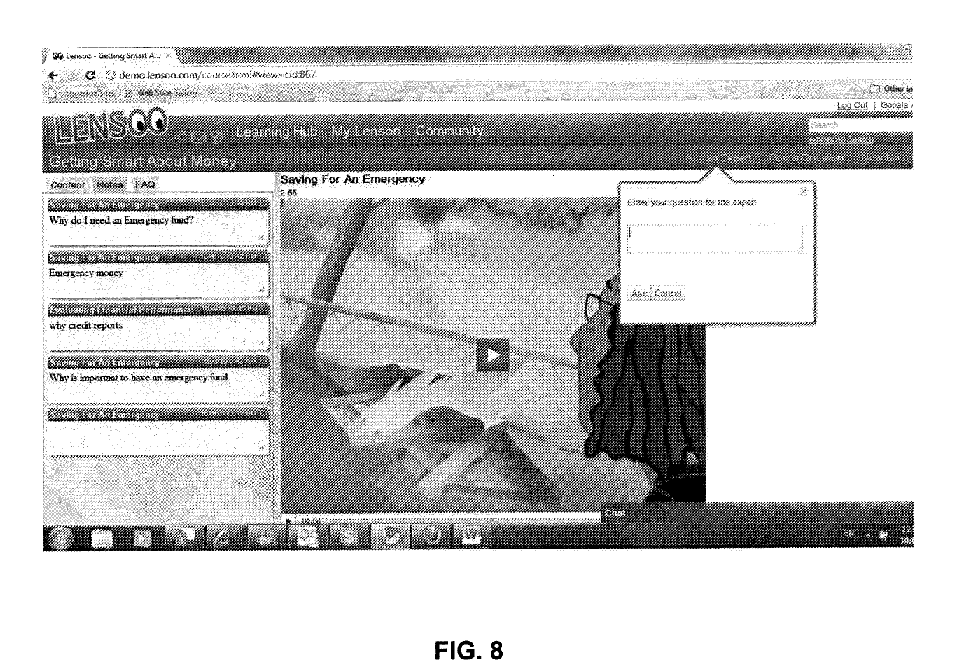

In FIG. 7 the learner's window also includes the “ask an expert” feature. When the “ask an expert” button is pressed, a list of all available experts with the ratings and numbers of learners providing the ratings are shown together with a price for a 10-minute session. The order of preference is given to course experts followed by subject matter experts. In at least one embodiment, a drop down menu is provided with a maximum of 10 experts shown, as well as a “next available” button to access additional experts. Clicking on the name of an expert takes a user to a webpage which will display the profile of the expert, including their qualifications or credentials. Once a user has made a selection of a particular expert, a check will be performed to ensure sufficient funds are available for interacting with that expert. Pre-paid course credits are available for users, and can be added to a users account and stored in the learner's vault. If there is not sufficient credit for the expert session, the user can be sent to the e-commerce engine (discussed above) to conduct a financial transaction. When the expert connects with the learner, the amount of funds or expert course credits is automatically deducted from the user's account if the user is satisfied with the answer of the user may rate the expert and provide feedback. The time period during which the expert works on the learner's request is solely determined by the expert and a visual cue is provided to the learner of the time being spent by the expert. If more than a 10-minute session is required, there is a feature in the expert chat for learner to pay for additional 10-minute sessions without terminating the current session. It should be noted that current implementation is a 10-minute session but the invention is not so limited, as a higher or lower increment of time may be used. FIG. 8 depicts a screenshot of an expert chat session within a graphical user interface. The illustrated embodiment depicts an example of an expert chat session, where a user can type in a question to be sent to the expert for response. The chat sessions can have audio or video components.

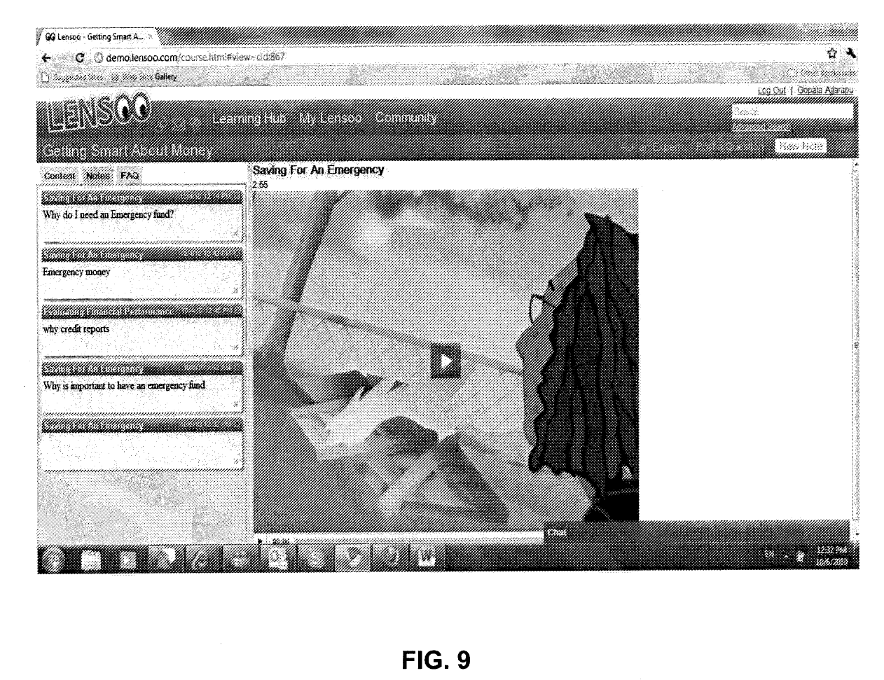

FIG. 9 depicts a screenshot showing the use of time-stamped, searchable notes within the graphical user interface. The illustrated embodiment depicts the use of “sticky notes.” As used herein, the term sticky notes refers to time-stamped, searchable notes linked to specific content at the time the note was taken. They are termed “sticky” because, when selected by user, they are configured to bring up the linked content in the display window corresponding to that particular note. The same is done for chat sessions linked to content.

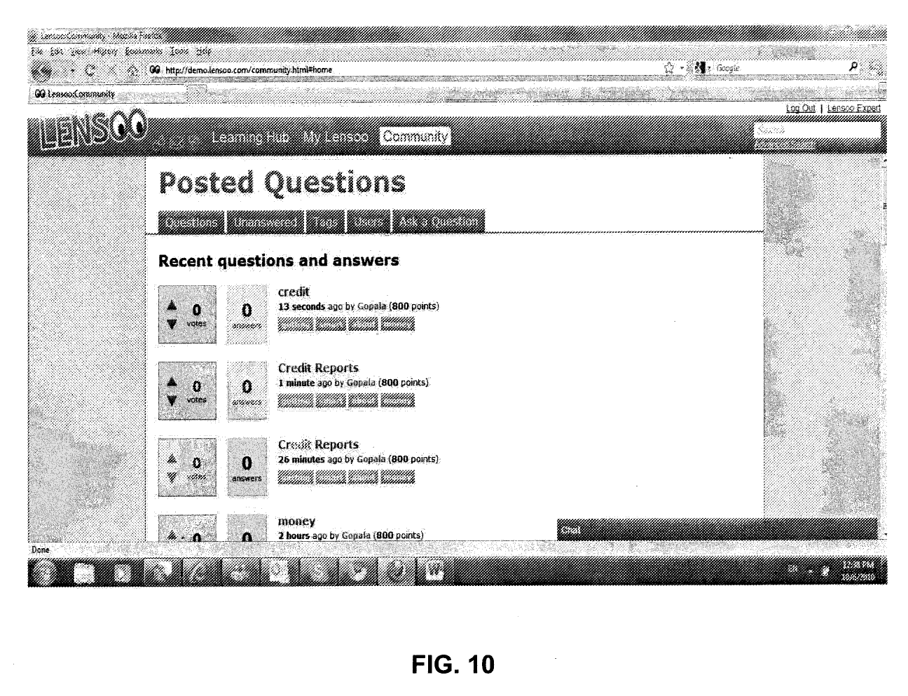

FIG. 10 depicts a screenshot of a community window within a graphical user interface. In the illustrated embodiment, the community can consist of various tabs showing community events, community contacts, community blogs, as well as posted questions within the community, and the ability to respond to them. The idea of community includes networking and socializing. For networking, in addition to being a member of the learning platform, a user may belong to a subject-based community or business groups sponsored by businesses. A user may also belong to multiple communities. A networking page may to be provided that includes: public profile of other community members, experts, businesses and business members; ability to request connection through e-mail for chat; public events related to the community; post a question or ask an expert within that particular community; or community blogging. For socializing, there'll also be a socializing page which will allow sharing of information, such as pictures, notes, etc. the learning platform provides collaboration amongst learners, instructors, content providers, and experts. This collaboration can be real-time or driven by email.

Since networking is a key element of the learning platform, establishing reputation for members of a particular community is important. As such, a rating and rewards system can be developed that offers rewards for contributing to building of the community. Reputation points may be given to individuals for contributing to building of the knowledge base in the community by performing functions such as posting a question, answering a question, ratings based on the quality of answers, or joining the community. Reputation points could also be made available for providing ratings for instructors, courses, and for experts within a particular community. Different statuses can be attributed to members who collect a particular number of reputation points such as designations of mentor or guru.

The description of the embodiments described herein provide for learning as a service (LaaS) in a learning network. The various data processing devices and systems that can be used with these embodiments are given for illustrative purposes only, and are not intended to represent any particular architecture or manner of interconnecting the components, as such details are not germane to the invention. It will be appreciated that network computers and other data processing systems, which have fewer components or perhaps more components, may also be used. These data processing systems may be any device which interacts with the Internet via a web browser such as, for example, workstations, personal computers (PCs) Apple Macintosh computers, or any other mobile communications device such as an Android, iPhone, iPad, or Blackberrry device, for example.

Additionally, data processing devices used to implement the techniques described herein may be specially constructed for specific purposes such as hardwired circuitry, or they may comprise general purpose computers selectively activated or configured by a computer program stored in a memory. Such a computer programs may be stored in an article of manufacture referred to as a computer-readable medium. A computer-readable medium can be used to store software instructions, which when executed by any data processing system, cause it to perform the various methods of this description. Computer-readable media may include any mechanism that provides information in an electronic format accessible by a computer such as a desktop or laptop computer, network device, PDA, or any other device having a set of one or more processors. For example, computer-readable media may include any type of disk including floppy disks, hard drive disks (HDDs), solid-state devices (SSDs), optical disks, CD-ROMs, magnetic-optical disks, ROMs, RAMs, EPROMs, EEPROMs, other flash memory, magnetic or optical cards, or any other type of media suitable for storing instructions in an electronic format.

What is claimed is:

1. A method of providing learning as a service (LaaS) in a learning network implemented in a computer system, the method comprising:
connecting users of the learning network with providers of pedagogic or professional content using an online marketplace for self-directed learning, wherein the online marketplace includes a database of searchable content;
providing a web-based graphical user interface (GUI) to users via the learning network, the web-based GUI to enable user interaction with the content without regard to time of access or location of the content, and to allow users to control the content and pace of learning;
receiving a request from a user for content of a particular content provider via the learning network; and
enabling self-directed learning by providing the requested content to the user in monetized components on a per-use basis while providing online availability of experts and community members within the web-based GUI.

2. The method of claim 1, further comprising:
receiving content from content providers via the learning network; and
storing the content in the database of searchable content indexed according to at least category and subject matter.

3. The method of claim 1, further comprising:
receiving identification information of a second user designated as a content expert by the content provider; and
enabling the user to communicate with, and receive instruction from, the content expert on a per-session basis to enable expert-guided learning of the content.

4. The method of claim 1, further comprising:
receiving a query from a third user requesting to be an expert in the subject matter of the content along with credentials of the third user;
designating the third user as a subject matter expert for the content when the third user's credentials are verified as meeting a standard for subject matter experts of the content; and
enabling the user to communicate with, and receive instruction from, the subject matter expert on a per-session basis to enable expert-guided learning of the content.

5. The method of claim 1, further comprising integrating a networking and a social media capability within the learning network to enable community-enabled learning of the content.

6. The method of claim 1, wherein the pedagogic or professional content is composed of modules and sub-modules, each of which can be uploaded from the learning network in any format or multiple formats without requiring an application to be loaded onto a local client of the user.

7. The method of claim 1, wherein the user interacts with the pedagogic or professional content by generating user data that is stored in a learner's vault database as searchable data linked to corresponding content in the database of searchable content.

8. The method of claim 7, wherein the generated user data includes time-stamped, searchable notes linked to the content, and wherein selection of each searchable note brings up the linked content in the user's web-based GUI.

9. The method of claim 1, wherein the learning network includes both public and private domains, wherein the private domains include functionality that is the same as functionality of the public domains, but the private domains limit access to designated groups.

10. An article of manufacture comprising a computer-readable medium having instructions stored thereon, which when executed by a computer system, cause the computer system to perform a method of providing learning as a service (LaaS) in a learning network, the instructions comprising:
instructions to connect users of the learning network with providers of pedagogic or professional content, experts, and community members using an online marketplace for self-directed learning, wherein the online marketplace includes a database of searchable content;
instructions to provide a web-based graphical user interface (GUI) to users via the learning network, the web-based GUI to enable user interaction with the content without regard to time of access or location of the content, and to allow users to control the content and pace of learning;
instructions to receive a request from a user for content of a particular content provider via the learning network; and
instructions to provide the requested content to the user in monetized components on a per-use basis.

11. The article of manufacture of claim 10, further comprising:
instructions to receive the content from content providers via the learning network; and
instructions to store the content in the database of searchable content indexed according to at least category and subject matter.

12. The article of manufacture of claim 10, further comprising:
instructions to receive identification information of a second user designated as a content expert by the content provider; and
instructions to enable the user to communicate with, and receive instruction from, the content expert on a per-use basis to enable expert-guided learning of the content.

13. The article of manufacture of claim 10, further comprising:
instructions to receive a query from a third user requesting to be an expert in the subject matter of the content along with credentials of the third user;
instructions to designate the third user as a subject matter expert for the content when the third user's credentials are verified as meeting a standard for subject matter experts of the content; and
instructions to enable the user to communicate with, and receive instruction from, the subject matter expert on a per-use basis to enable expert-guided learning of the content.

14. The article of manufacture of claim 10, further comprising instructions to integrate a networking and a social media capability within the learning network to enable community-enabled learning of the content.

15. The article of manufacture of claim 10, wherein the pedagogic or professional content is composed of modules and sub-modules, each of which can be uploaded from the learning network in any format or multiple formats without requiring an application to be loaded onto a local client of the user.

16. The article of manufacture of claim 10, wherein the user interacts with the pedagogic or professional content by generating user data that is stored in a learner's vault database as searchable data linked to corresponding content in the database of searchable content.

17. The article of manufacture of claim 16, wherein the generated user data includes time-stamped, searchable notes linked to the content, and wherein selection of each searchable note brings up the linked content in the user's web-based GUI.

18. The article of manufacture of claim 10, wherein the learning network includes both public and private domains, wherein the private domains include functionality that is the same as functionality of the public domains, but the private domains limit access to designated groups.

19. A platform for learning as a service (LaaS) in a learning network, the platform comprising:
a communications engine configured to connect users of the learning network with providers of pedagogic or professional content, experts, and community members using an online marketplace for self-directed learning;
a database of searchable pedagogic or professional content coupled with the communications engine;
a learning engine coupled with the communications engine and the database of searchable content, the learning engine configured to:
(a) receive requests from users for content of a particular content provider and to provide the requested content to the user in monetized components on a per-use basis;
(b) provide online availability of experts and community members; and
(c) provide a web-based graphical user interface (GUI) window to the user to enable user interaction with the content via the learning network without regard to time of access or location of the content, wherein the web-based GUI allows users to control the content and pace of learning.

20. The platform of claim 19, wherein the learning engine is further configured to:
receive content from content providers via the learning network; and
store the content in the database of searchable content indexed according to at least category and subject matter.

21. The platform of claim 19, further comprising a media conversion engine coupled with the database of searchable content, the media conversion engine configured to convert media from a first format to any other format.

22. The platform of claim 19, further comprising a search engine coupled with the database of searchable content, the search engine configured to allow users to search for and obtain pedagogic or professional content.

23. The platform of claim 19, further comprising a e-commerce engine coupled with the learning engine, the e-commerce engine configured to:
communicate with financial systems to provide billing, collections, and corporate reporting functionality for the platform; and
enable transactions over the learning network.

24. The platform of claim 19, wherein the learning engine is further configured to:
receive identification information of a second user designated as a content expert by the content provider; and
enable the user to communicate with, and receive instruction from, the content expert on a per-use basis to enable expert-guided learning of the content.

25. The platform of claim 19, wherein the learning engine is further configured to:
receive a query from a third user requesting to be an expert in the subject matter of the content along with credentials of the third user;
designate the third user as a subject matter expert for the content when the third user's credentials are verified as meeting a standard for subject matter experts of the content; and
enable the user to communicate with, and receive instruction from, the subject matter expert on a per-use basis to enable expert-guided learning of the content.

26. The platform of claim 19, wherein the pedagogic or professional content is composed of modules and sub-modules, each of which can be uploaded from the learning network in any format or multiple formats without requiring an application to be loaded onto a local client of the user.

27. The platform of claim 19, wherein the database of searchable content includes a learner's vault wherein the user interacts with the pedagogic or professional content by generating user data that is stored in the learner's vault as searchable data linked to the content in the database of searchable content.

28. The platform of claim 27, wherein the generated user data includes time-stamped, searchable notes linked to the content, and wherein selection of each searchable note brings up the linked content in the user's window.
